(19) United States
(12) Patent Application Publication
(10) Pub. No.: US 2005/0191986 A1
(43) Pub. Date: Sep. 1, 2005

(54) FM detector for direct-conversion receiver

(76) Inventors: Hung C. Lin, Spring Spring, MD (US); Chiang H. Yeh, Gaithersburg, MD (US)

Correspondence Address: HungChang Lin, 8 Schindler Ct., Silver Spring, MD, 20903, US

(21) Appl. No.: 10/787,274

(22) Filed: Feb. 27, 2004

(51) Int. Cl. H04B 1/00; H04B 1/16; H04B 1/06

(52) U.S. Cl. 455/336; 455/263; 455/214

(57) ABSTRACT

The in-phase intermediate frequency signal and the quadrature intermediate frequency signal of a direct conversion FM receiver are applied to a mixer or multiplier serving as a detector, and the output of the mixer yields the demodulated FM signal.

### BACKGROUND OF THE INVENTION

1. Field of the Invention

This invention relates to FM detectors, in particular to FM detector for direct-conversion receivers with quadrature downconversion.

2. Brief Description of Related Art

An FM detector is used to convert frequency deviations from the carrier frequency of the FM signal into voltage amplitude variations. Commonly used FM detector are the slope detector and the quadrature detector. In the slope detector as shown in FIG. 1a, the carrier frequency is tuned not at the peak but at the slope of the frequency response of a resonant circuit as shown in FIG. 1b, and the amplitude response changes as frequency departs from the carrier frequency. In the quadrature detector, the carrier frequency signal is mixed with the quadrature signal as shown in FIG. 2, and then the output voltage of mixer is proportional the frequency deviation of the FM signal.

In recent years, the direct-conversion radio receivers with quadrature downconversion become popular for improved image suppression and simplification of intermediate frequency filtering. FIG. 3 shows the architecture of a direct-conversion receiver. The incoming RF input signal is converted by an in phase component LO_{I} of local oscillator LO and a quadrature phase component LO_{Q} of local oscillator LO with same local oscillation frequency as the RF input signal VFM. The two converted signals are then filtered by low-pass filters LPI and LPQ to yield an in-phase signal VIFIL and a quadrature signal VIFQL. If the input RF signal is frequency modulated, then each of the converted signal VIFIL and the converted signal VIFQL may require an individual FM detectors DETI and DETQ such as that shown in FIG. 1a or FIG. 2 to demodulate the modulated FM signals into voltage amplitude variations VDEM. The two demodulated signals may combine in a summer.

### SUMMARY OF THE INVENTION

An object of this invention is to simplify the detection of an FM signal for a direct-conversion receiver. Another object of this invention is to use one FM detector to detect two converted quadrature FM signals.

These objects are achieved by mixing the converted in-phase signal and the converted quadrature signal in a mixer, and the output of the mixer yields the amplitude variation proportional to the frequency deviation from the carrier.

### BRIEF DESCRIPTION OF THE DRAWINGS

FIG. 1a shows a slope detector for FM signals; and FIG. 1b shows the frequency response of the slope detector.

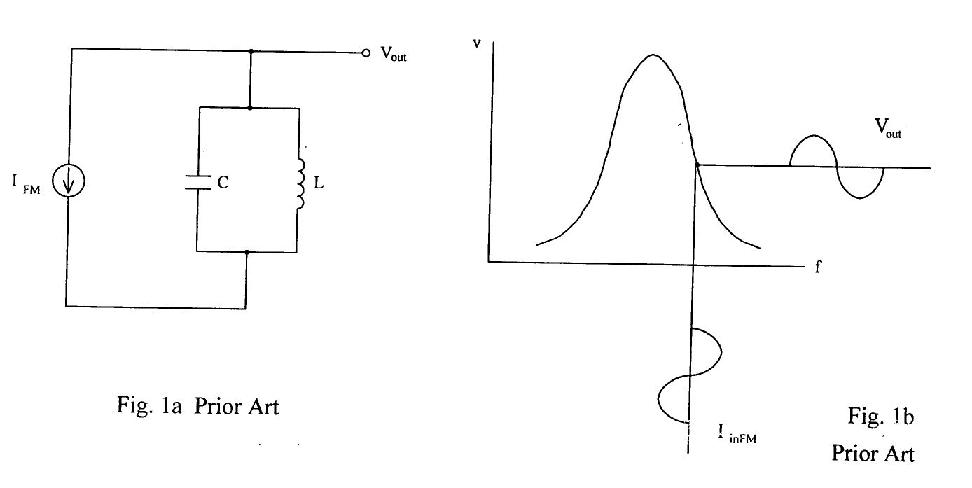

FIG. 2 shows a quadrature phase FM detector.

FIG. 3 shows the architecture of a direct-conversion receiver.

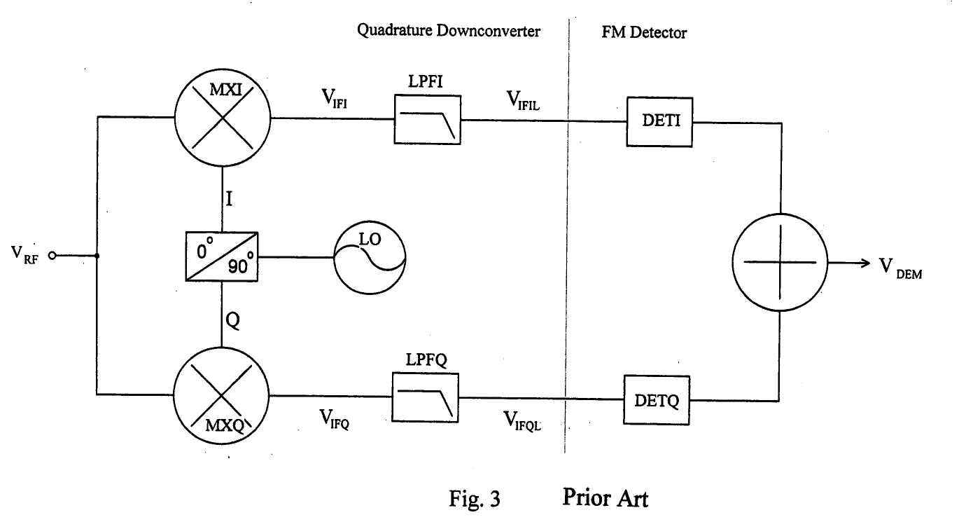

FIG. 4 shows the basic block diagram of the present invention.

### DETAILED DESCRIPTION OF THE INVENTION

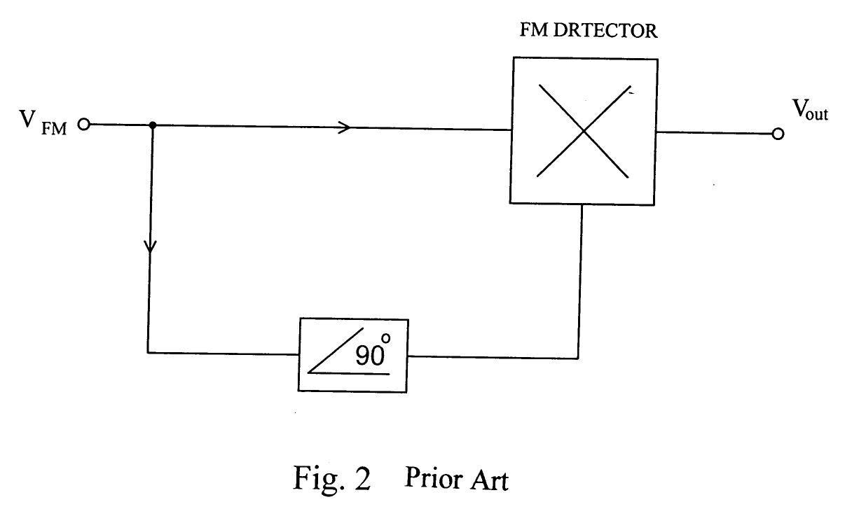

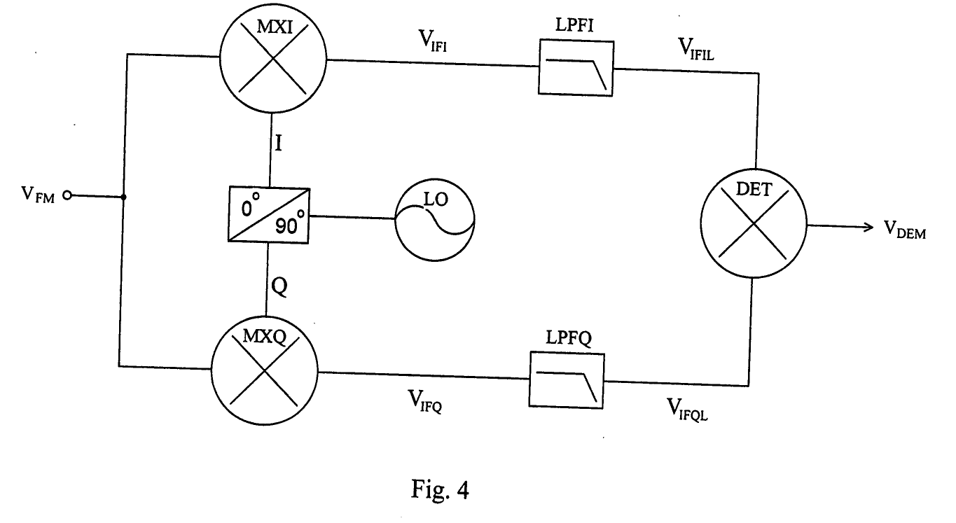

The basic block diagram of the present invention is shown in FIG. 4. An incoming RF signal VFM is mixed in mixer MXI with the in-phase output LOI of a local oscillator LO to produce an in-phase beat frequency signal, VIFI. The incoming signal VFM is also mixed with the quadrature output of the local oscillator to produce a quadrature beat frequency signal, VQIF. After passing through a low pass-filter LPFI to remove the higher beat frequency component, the output VIFIL from the LPFI is applied to a mixer DET. After passing through a low-pass filter LPFQ to remove the higher beat frequency component, the output VIFQL from the LPFQ is mixed with VIFQL in mixer DET. Since VIFIL and VIFQL are in quadrature, the mixer DET operates as an FM detector as depicted in FIG. 2.

There are many methods to mix two signals. The Gilbert cell is a popular mixer. Another method is to use an Exclusive OR. The Exclusive-OR has the advantage of serving as a limiter to avoid any imbalance between the VIFIL and VIFQL. Any other kinds of multipliers can serve as a mixer, hence an FM detector.

While the FM detector is described for a direct-conversion receiver, which implies that one of the beat frequency (IF) signals has a zero-frequency component, this invention is not limited to zero-frequency IF signals. Any architecture having an in-phase component of the IF signal and a quadrature component of the IF signal can use the FM detector of the present invention, e.g. the low IF architecture and the Weaver architecture.

While the preferred embodiments of the present invention have been described, it will be apparent to those skilled in the art that various modifications may be made in the embodiments without departing from the spirit of this present invention. Such modifications are all within the scope of the present invention.

1. An FM detector for a direct-conversion receiver with an FM input signal comprising:
a frequency-modulated (FM) RF input signal;
a local oscillator having an in-phase frequency local oscillator signal (VLOI) and a quadrature frequency local oscillator signal (VLOQ);
a first mixer to mix said FM RF signal and said VLOI to produce an in-phase beat frequency signal VIFI;
a second mixer to mix said FM RF signal and said VLOQ to a quadrature beat frequency signal VIFQ; and
a third mixer to mix said VIFI and VIFQ to serve as an FM detector and to output a demodulated signal.

2. The FM detector as described in claim 1, further comprising a first low-pass filter inserted between said first mixer and said FM detector, and a second low-pass filter inserted between said second mixer and said FM detector.

3. The FM detector as described in claim 1, wherein said in-phase beat frequency and said quadrature beat frequency are is lower than the RF input signal frequency.

4. The FM detector as described in claim 3, wherein said in-phase beat frequency and said quadrature beat frequency are of zero frequency.

5. The FM detector as described in claim 1, wherein said third mixer is a multiplier.

6. The FM detector as described in claim 5, wherein said multiplier is a Gilbert cell.

7. The FM detector as described in claim 5, wherein said multiplier is an Exclusive-OR gate.
